(19) United States
(12) Patent Application Publication
(10) Pub. No.: US 2010/0046419 A1
(43) Pub. Date: Feb. 25, 2010

(54) Overlay Network Node, Mobile Node, and Mobile Router

(75) Inventors: Jun Hirano, Kanagawa (JP); Chan Wah Ng, Singapore (SG); Mohana Dhamayanthi Jeyatharan, Singapore (SG); Tien Ming Benjamin Koh, Singapore (SG); Pek Yew Tan, Singapore (SG)

Correspondence Address: Dickinson Wright PLLC;James E. Ledbetter, Esq., International Square, 1875 Eye Street, N.W., Suite 1200, Washington, DC, 20006, US

(73) Assignee: PANASONIC CORPORATION, Osaka (JP)

(21) Appl. No.: 12/595,231

(22) PCT Filed: Apr. 9, 2008
(86) PCT No.: PCT/JP2008/000910

§ 371 Date: Oct. 8, 2009

(30) Foreign Application Priority Data
Apr. 12, 2007 (JP) 2007-104900

(51) Int. Cl. H04W 40/00; H04B 7/14

(52) U.S. Cl. 370/315; 370/328

(57) ABSTRACT

A technique is disclosed, by which generation of redundant signaling caused by processing to establish route optimization can be suppressed. According to this technique, an overlay network is formed on a network, and an overlay network service of home agent is provided by a pHA (proxy home agent) 124. An MR (mobile router) 130 and a VMN (visiting mobile node) 140 connected to the mobile network are both subscribed in the overlay network service. In this case, when MR is going to perform optimization processing of a route to a home agent of VMN, pHA transmits change-HA messages 216 and 218 to notify VMN to change the home agent to the home agent of MR. When VMN changes the home agent to the home agent of MR, MR recognizes that processing of route optimization to the home agent of VMN is not needed.

### TECHNICAL FIELD

The present invention relates to an overlay network node, which fulfills the functions as a node in an overlay network, and which is abstractly represented in a packet-exchange type data communication network such as an IP (Internet Protocol) network.

### BACKGROUND ART

At present, a multiple of devices are performing communication with each other by using Internet protocol. For the purpose of providing mobility support for mobile devices, mobility support in IPv6, or mobile IP, (see the Non-Patent Document 1 as given below) is defined by IETF (Internet Engineering Task Force). In mobile IP, each mobile node has a constant home domain. When the mobile node is connected to its own home network, a primary global address known as a home address (HoA) is assigned to the mobile node. On the other hand, when the mobile node is separated away from the home network, i.e. when it is connected to other foreign network, a temporary global address known as a care-of address (CoA) is normally assigned to the mobile node. The concept of the mobility support is such that, even when the mobile node is connected to the other foreign network, the mobile node can be reached by using its own home address.

According to the Non-Patent Document 1, this concept is practically carried out by introducing an entity known as a home agent (HA) to the home network. The mobile node registers a care-of address to the home agent by using a message known as a binding update (BU) message. As a result, the home agent can generate a binding between the home address and the care-of address of the mobile node. The home agent intercepts the message destined to the home address of the mobile node, and transfers the packet to the care-of address of the mobile node by encapsulating the packet (i.e. by setting a packet as a payload of a new packet; also known as packet tunneling).

On the other hand, the number of wireless devices is increasingly used further, and it is anticipated that a new technical class will emerge in the mobility technique. One of such new technical classes is a network mobility, in which the entire network including the nodes changes the connection point. In the network mobility, it is aimed to provide a mechanism, by which it is possible to reach a node within a mobile network by referring to a primary global address even when the mobile network is connected to Internet at any connection point as a solution relating to the network, which is moving in case the concept of the mobility support is extended to the mobility support for the network including the node.

In IETF, the network mobility in the Non-Patent Document 2 as given below is described. It is described in the Non-Patent Document 2 that, when a BU (binding update) message is transmitted by a mobile router to a home agent, the mobile router indicates a network prefix used by the node within the mobile network. By putting a specific option called a network prefix option in the BU message, the mobile router can designate the network prefix. As a result, the home agent builds up a routing table based on the prefix, and the packet to be transmitted to a destination address having this network prefix can be transferred to the care-of address of the mobile router.

This technique is one of the simple and accurate methods to provide the mobility support. However, the packet to be transmitted and received by the mobile node must pass the home agent, and packet transmission may be delayed while the packet is passing through a redundant route. Further, when the mobile network is behind another mobile network and it is in nested condition, the packet is encapsulated for two or more times, and the packet must pass through a plurality of home agents until it reaches the destination as desired.

To cope with such situation, various proposals have been made to optimize the tunnel under nested condition in the related technical field.

In particular, in the Patent Document 1 and the Patent Document 2 as given below, a method of solution known as release of access router option is proposed. In this case, a new option is defined on a mobility header as provided in the Mobile IPv6.

This new option as referred as access router option is used to notify a primary global address of an access router, to which the transmitter is connected, from a transmitter (i.e. a mobile router or a mobile host) to a receiver (a home agent or a correspondent node).

After a binding update message where the access router option is set is transmitted, the mobile node can place a specific signal (referred as a “direct transfer request” signal) in the data packet to be transmitted by the mobile node. By this signal, a mobile access router upstream transmits its own binding update message to the destination. This processing is carried out repeatedly until the mobile access router of the uppermost position is reached.

When all of the mobile access routers upstream transmit the binding update to the destination node, the destination node can acquire information of nexus or tie (in nested condition) of the mobile access router, to which the mobile node is connected. By an extension routing header of type 2, this information can be utilized. In this case, when the destination node is going to send back the packet to the mobile node, the destination node embeds a routing header in the packet, and the packet can be directly transferred to the mobile node via nexus of a series of mobile access routers (without passing through the home agents).

Also, route optimization of another form based on network element is described in the Non-Patent Document 3 and the Patent Document 3 as given below. Now, referring to FIG. 1A, description will be given on this point.

FIG. 1A shows an example of a case where an overlay network 110 is arranged in a global communication network 10 such as Internet. The overlay network 110 comprises a home agent (HA) 120 and proxy home agents, i.e. pHA 122, pHA 124, pHA 126, and pHA 128. Near pHA 122, pHA 124 and pHA 126, there are access networks 12, 14 and 16 respectively. A mobile node (MN) 135 is a mobile node, which moves in the global communication network 10, and home agent and home network are a HA 120 and a home network 100 respectively.

It is assumed here that MN 135 is performing communication with a correspondent node (CN) 30. By NEMO basic support, a packet to be transmitted from MN 135 to CN 30 is encapsulated, and the packet is sent—first via a route 40 to MR 130. In this case, MR 130 encapsulates the packet and tunnels the packet to HA 120 as shown by a route 42. HA 120 decapsulates the packet and transfers an actual data packet (an inner packet) to CN 30 via a route 44. While it depends on relative positions of the mobile network 102 and CN 30 with respect to HA 120, a transmission route of the packet will be considerably longer than the shortest path between MN 135 and CN 30. As a result, considerable delay occurs in the packet transmission.

In the overlay network of a global home agent, a system of home agent and proxy home agent is arranged on the global communication network 10. When the mobile network moves out of the home network, a proxy home agent located at a position closest to a mobile router to control the mobile network is assigned. A packet to be transmitted and received by the mobile network is transferred between two proxy home agents, which are closest to the transmission source (a mobile network node) and the destination (a correspondent node, with which the mobile network node is performing communication) in the overlay network.

Describing now by referring to the example shown in FIG. 1A, in case MR 130 is connected to an access network 14, pHA 124 fulfills the function as a proxy home agent. That is, a binding update information and the encapsulated data packet are transferred to pHA 124, and the processing is carried out by pHA 124 on behalf of HA 120.

For instance, when MN 135 transmits a data packet to CN 30, MR 130 encapsulates the packet and transmits it to pHA 124 (route 50). After performing decapsulation, pHA 124 identifies that the destination (i.e. CN 30) is at a position closest to pHA 122 of the overlay network 110. Then, the data packet is transferred to pHA 122 via a route 52. This transfer is carried out via a tunnel between pHA 122 and pHA 124. Then, pHA 122 transfers the packet to CN 30 via a route 54.

As it is evident when the routes (routes 42 and 44) not using the overlay network 110 are compared with the routes (routes 50, 52 and 54) using the overlay network 110, in case the overlay network 110 of a global home agent is used, a shorter packet transmission path is accomplished. In this way, the overlay network 110 is advantageous in that the route optimization can be accomplished transparently to a mobile node or to a correspondent node. The route optimization provided by network is also described in the Patent Document 4 and the Patent Document 5 as given below.

In the Patent Document 4, a network-based route optimization method is disclosed. According to the technique disclosed in the Patent Document 4, actual position of a mobile node moving in wireless LAN or in 3G network (3rd generation network) is updated at a mobile switching center of 3G1X system. As a result, the mobile switching center can directly transmit a message to actual position of the mobile node instead of transmitting it via a home network of the mobile node.

In the Patent Document 5, a method to use the Mobile IPv4 environment is disclosed. According to this method, the packet is directly forwarded to a foreign agent, to which the mobile node is connected, instead of passing via the home agent of the mobile node.

Further, in the Patent Document 6, a home agent synchronizing method for transmitting the binding update, by which a certain home agent can transmit the binding update to another home agent.

In this overlay network, it is evident that route optimization can also be accomplished similarly—not only to a mobile router but also to a mobile host. For example, in FIG. 1A, a visiting mobile node (VMN) 140 in a mobile network 120 can be subscribed in the overlay network 110 of the home agent.

[Patent Document 1] International Application Publication No. WO 2004-036841
[Patent Document 2] International Application Publication No. WO 2005-094015
[Patent Document 3] International Application Publication No. WO 2006-064960
[Patent Document 4] U.S. Patent Application Publication No. WO 2005-0276273 A1
[Patent Document 5] International Application Publication No. WO 2000-054523
[Patent Document 6] International Application Publication No. WO 2006-068439

### [Non-Patent Document 1] Johnson, D. B., Perkins, C. E. and Arkko, J.: “Mobility Support in IPv6”; Internet Engineering Task Force Request For Comments 3775; June 2004.

### [Non-Patent Document 2] Devarapalli, V., et al.: “NEMO Basic Support Protocol”; Internet Engineering Task Force Request For Comments 3963; January 2005.

[Non-Patent Document 3] Thubert, P., et al.; Global HA to HA protocol”; Internet Draft: draft-thubert-nemo-global-haha-02.txt; Sep. 28, 2006.

However, in FIG. 1A, for instance, both of the mobile router (MR) 130 and VMN 140 are subscribed in the overlay network 110 of the home agent. If the mobile router (MR) 130 and visiting mobile node (VMN) 140 both attempt to perform route optimization processing to optimize a tunnel in nested condition, redundant signaling may be generated. On this problem, description will be given below by referring to FIG. 1B.

FIG. 1B shows a sequence chart of messages when VMN 140 and MR 130 are using route optimization in nested condition and network-based route optimization is transparently provided to these nodes.

In FIG. 1B, MR 130 first transmits a BU message 60 to a home agent (home agent of MR 130). Because MR 130 is connected to an access network 14, pHA 124 takes up the role of a home agent relating to MR 130 and performs processing on the BU message 60.

Next, VMN 140 transmits a BU message 70 to a home agent (home agent of VMN 140). MR 130 encapsulates this message and transmits it by tunneling as a tunnel packet 72. Then, pHA 124, acting as a home agent of MR 130, decapsulates this tunnel packet and detects the BU message transmitted from VMN 140. VMN 140 is also a subscriber of the overlay network 110 of the home agent, and pHA 124 takes up the role as a home agent of VMN 140 for VMN 140. As a result, the processing of the BU message from VMN 140 is carried out at pHA 124.

It is supposed here that, when MR 130 transfers the BU message 70 via tunnel, route optimization is decided to be performed on a route to and from the destination as described in the BU message 70. In this case, MR 130 initiates a return routability (RR) process 74 with the destination of the BU message 70. After this processing, a BU message 76 is transmitted to the home agent of VMN 140. If this processing is successfully performed, MR 130 describes the destination (i.e. the home agent of VMN 140) in a binding update list, and MR 130 transmits binding information to the destination.

In case MR 130 changes connection point or after a predetermined time-out period 80 has elapsed, MR 130 must update the node as described in the binding update list. As a result, MR 130 transmits a BU message 82 to its own home agent. In this case, pHA to take up the role of the home agent of MR 130 (pHA 124 when the connection point is not moved) intercepts and processes this packet. Further, MR 130 initiates the return routability process 84, and a BU message 86 is transmitted to the home agent of VMN 140.

In the operation as described above, a problem arises that redundant signaling is generated in the return routability processes 74 and 84 and at the BU messages 76 and 86 because VMN 140 and MR 130 are subscribed in the overlay network of the same home agent. This is because MR 130 (or VMN 140 depending on the case) is transmitting the BU messages 60 and 70 to have the same effect (to notify binding of the mobile network 120 and care-of address of MR 130 to the overlay network 110).

### DISCLOSURE OF THE INVENTION

To solve the above problems, it is an object of the present invention to provide the means to reduce generation of redundant signaling, which may be generated when a mobile router receives a network-based route optimization service as provided by an overlay network and also when a mobile node (a visiting mobile node (VMN)) connected to the mobile router receives a network-based route optimization service provided by the overlay network.

To attain the above object, the overly network node of the present invention provides an overlay network node, belonging to an overlay network formed on top of a predetermined network, and having functions relating to an overlay network service of a home agent, comprising:

means for identifying a mobile router or a mobile node subscribed in said overlay network service; and

message transmitting means for detecting a condition where a mobile node receiving said overlay network service is connected to a mobile network of a mobile router, and receiving said overlay network service, and for, when a message relating to route optimization processing is received from said mobile router, transmitting a notification message to said mobile router or said mobile node in order to suppress transmission of a message relating to the route optimization processing from said mobile router.

With the arrangement as described above, generation of redundant signaling can be reduced when the mobile router receives a network-based route optimization service provided by the overlay network and also when the mobile node connected to this mobile router receives a network-based route optimization service provided by the overlay network.

Further, in addition to the arrangement as described above, the present invention provides the overlay network node as described above, wherein said message transmitting means transmits said notification message to instruct to change the home agent of said mobile node to a predetermined home agent.

With the arrangement as described above, it is possible to move the route termination node from the mobile router to the node on the network and to prevent generation of redundant signaling caused by route optimization at the mobile router.

Also, in addition to the arrangement as described above, the present invention provides the overlay network node as described above, wherein said predetermined home agent is a home agent of said mobile router.

With the arrangement as described above, the home agent of the mobile router is turned to the same as the home agent of the mobile node, and it is possible to prevent generation of redundant signaling relating to route optimization by the mobile router.

Further, in addition to the arrangement as described above, the present invention provides the overlay network node as described above, comprising means for discarding a message relating to route optimization processing to the home agent before the change of said mobile node from said mobile router after said notification message is transmitted by said message transmitting means.

With the arrangement as described above, it is possible to prevent the mobile router from performing the processing of useless route optimization.

Also, in addition to the arrangement as described above, the present invention provides the overlay network node as described above, comprising means for confirming whether said mobile node can understand said notification message before transmission of said notification message by said message transmitting means.

With the arrangement as described above, the mobile router, which cannot understand, can be prevented from transmitting a notification message.

Further, in addition to the arrangement as described above, the present invention provides the overlay network node as described above, comprising means for notifying to said mobile router that route optimization processing for said mobile node by said mobile router is not needed.

With the arrangement as described above, it is possible to prevent the mobile router from performing the processing of useless route optimization.

Also, in addition to the arrangement as described above, the present invention provides the overlay network node as described above, wherein said message transmitting means transmits, to said mobile router, said notification message to instruct that an optimized route of communication being carried out by said mobile router is terminated in a predetermined node on a network.

With the arrangement as described above, it is possible to shift a route termination node from the mobile router to a node on the network and to prevent generation of redundant signaling caused by route optimization at the mobile router.

Further, in addition to the arrangement as described above, the present invention provides the overlay network node as described above, wherein said predetermined node is a home agent of said mobile router.

With the arrangement as described above, the home agent of the mobile router can be designated as a route termination node.

Also, in addition to the arrangement as described above, the present invention provides the overlay network node as described above, comprising means for confirming whether said mobile router can understand said notification message or not before transmission of said notification message by said message transmitting means.

With the arrangement as described above, the mobile router, which does not understand, can be prevented from transmitting a notification message.

Further, in addition to the arrangement as described above, the present invention provides the overlay network node as described above, comprising means for judging which of processings should be performed among a processing to instruct said mobile node to change the home agent of said mobile node to a predetermined home agent, and a processing to instruct said mobile router that an optimized route of communication being performed by said mobile router is terminated in a predetermined node on a network.

As a result, adequate processing to reduce redundant signaling can be selected according an arbitrary condition (e.g. which of the mobile node or the mobile router corresponds well to the present invention).

To attain the above object, the present invention provides a mobile router subscribed in an overlay network service of a home agent, comprising:

means for receiving, from an overlay network node providing said overlay network service, a notification message to instruct that an optimized route of communication is terminated in a predetermined node on the network, and

means for performing processing to make a predetermined node to terminate a route of said communication.

With the arrangement as described above, it is possible to reduce redundant signaling, which may be generated when the mobile router receives a network-based route optimization service provided by the overlay network and also when the mobile node connected to the mobile router receives a network-based route optimization service provided by the overlay network.

Also, in addition to the arrangement as described above, the present invention provides the mobile router as described above, comprising means for verifying validity of said predetermined node to be notified by said notification message.

With the arrangement as described above, the validity of a certain node as notified (route termination node) can be verified.

Further, in addition to the arrangement as described above, the present invention provides the mobile router as described above, comprising means for storing an address of said predetermined node to be notified by said notification message.

With the arrangement as described above, it is possible to store the address of a predetermined notified node (route termination node).

Also, in addition to the arrangement as described above, the present invention provides the mobile router as described above, comprising means for confirming whether an optimized route is established or not on communication with said predetermined node to be notified by said notification message and for establishing the optimized route if the optimized route is not established.

With the arrangement as described above, it is possible to optimize communication between the route termination node and the mobile router.

Further, in addition to the arrangement as described above, the present invention provides the mobile router as described above, wherein there are provided:

means for receiving a notification from said mobile router or said specific mobile node that route optimization processing for a specific mobile node connected to own mobile network is not needed; and

means for deleting information of route optimization relating to said specific mobile node from its own binding update list.

With the arrangement as described above, the mobile router can be prevented from performing the processing of useless route optimization.

To attain the above object, the present invention provides a mobile node, being subscribed in an overlay network service of a home agent, comprising:

means for receiving, from an overlay network node providing said overlay network service, a notification message to instruct to change the home agent to a predetermined home agent; and

means for performing processing to change the home agent to said predetermined home agent.

With the arrangement as described above, it is possible to reduce redundant signaling, which may be generated when the mobile router receives a network-based route optimization service provided by the overlay network and also when the mobile node connected to the mobile router receives a network-based route optimization service provided by the overlay network.

Also, in addition to the arrangement as described above, the present invention provides a mobile node, comprising means for storing an address of said predetermined home agent to be notified by said notification message.

With the arrangement as described above, it is possible to store an address of a new home agent as notified.

Further, in addition to the arrangement as described above, the present invention provides a mobile node, comprising means for controlling in such manner that a packet is not transmitted to a home agent before change until a predetermined time period elapses.

With the arrangement as described above, it is possible to eliminate communication with the home agent before change, and to suppress generation of redundant signaling by deleting entry of the home agent from the binding update list of other node (a mobile router where the mobile node is connected).

Also, in addition to the arrangement as described above, the present invention provides a mobile node, comprising means for notifying said mobile router that route optimization processing for said mobile node by said mobile router is not needed.

With the arrangement as described above, the mobile router can be prevented from performing the processing of useless route optimization.

The present invention has the arrangement as described above and provides such effects that redundant signaling can be reduced, which may be generated when the mobile router receives a network-based route optimization service provided by the overlay network and also when the mobile node connected to the mobile router receives a network-based route optimization service provided by the overlay network.

### BRIEF DESCRIPTION OF THE DRAWINGS

FIG. 1A is a schematical drawing to show an example of network arrangement of the prior art and in each of a first embodiment and a second embodiment of the invention;

FIG. 1B is a sequence chart of messages when network-based route optimization is performed in the prior art;

FIG. 2 is a sequence chart of messages relating to a method to change the home agent in the first embodiment of the invention;

FIG. 3 is a drawing to show an example of format of a change-HA message in the first embodiment of the invention;

FIG. 4 is a drawing to show a preferred functional architecture of a VMN (visiting mobile node) in the first embodiment of the invention;

FIG. 5 is a sequence chart of messages relating to a method of correspondent router in the second embodiment of the invention;

FIG. 6 is a drawing to show an example of format of a Use-CR message in the second embodiment of the invention;

FIG. 7 is a drawing to show a preferred functional architecture of MR (mobile router) in the second embodiment of the invention; and

FIG. 8 is a flowchart of an example of algorithm to be used by a proxy home agent to process a received packet according to the first embodiment and the second embodiment of the invention.

### BEST MODE FOR CARRYING OUT THE INVENTION

Description will be given below on embodiments of the present invention by referring to the attached drawings.

According to the present invention, the problem of generation of excessive signaling can be solved in the case where both of a mobile router and a mobile network node connected to a mobile network of this mobile router are subscribed in an overlay network of the same home agent. As the methods to solve the problem, the invention provides the following two methods:

According to a first method (hereinafter, may be referred as “a method to change home agent”), a mobile network node must be primarily provided with new functions. On the other hand, according to a second method (hereinafter, may be referred as “a method of correspondent router”), the mobile router must be provided with new function.

### 1st Embodiment

First, description will be given on a method to change home agent in the first embodiment of the invention. In this method to change home agent, it is notified basically from an overlay network of the home agent to a mobile network node that the home agent assigned to the mobile network node has been changed to the same home agent as that of the mobile router. As a result, the mobile network node and the mobile router perform communication with the same home agent (actually, a proxy home agent, which is at the closest position on the overlay network).

When the mobile router is going to initiate route optimization on behalf of the mobile network node, the mobile router discovers that the mobile network node is performing communication with its own home agent (i.e. a home agent, to which current binding between the home address and the care-of address of the mobile router is already notified). Then, the mobile router recognizes that there is no need to carry out the processing of route optimization on behalf of the mobile network node, and this prevents the transmission of excessive signaling message relating to the route optimization.

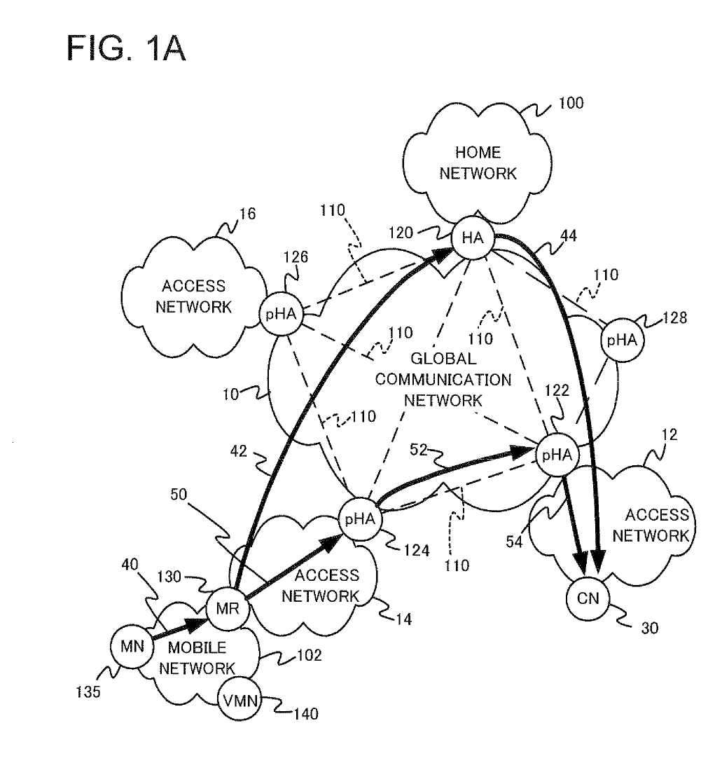

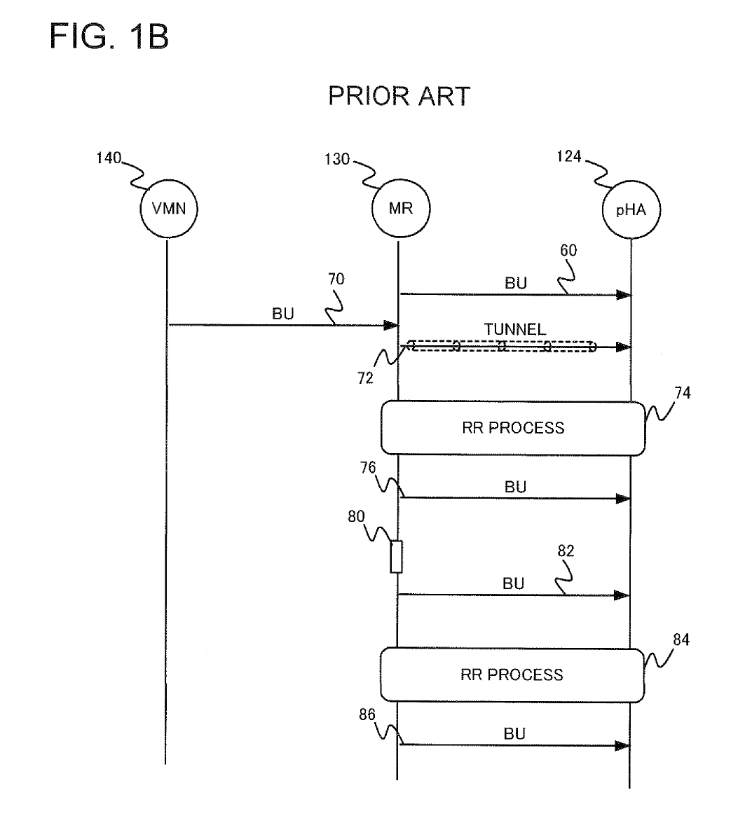

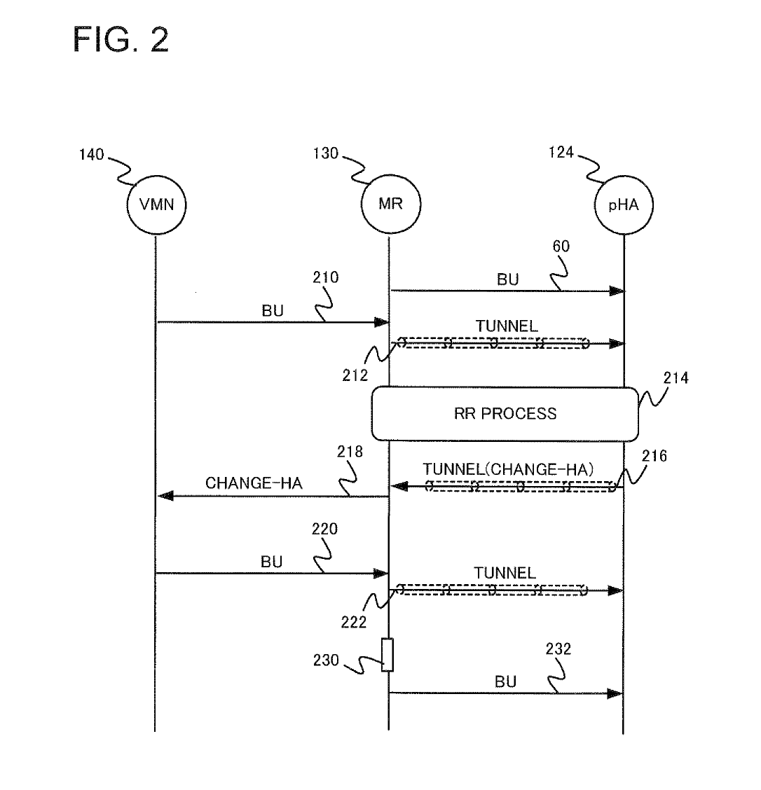

Now, referring to FIG. 2, description will be given on operation in the first embodiment of the invention. It is assumed that FIG. 2 is based on the arrangement shown in FIG. 1A. Specifically, VMN 140 is connected to MR 130. Further, MN 130 is connected to an access network 14. In an overlay network 110 of the home agent, pHA 124 is transparently assigned to home agents of MR 130 and VMN 140. An arbitrary node (e.g. pHA 124) of the overlay network 110 must confirm that MR 130 or VMN 140 is a subscriber of the overlay network 110 of the home agent. In the present invention, there is no specific limitation to the method of this confirmation, and any confirmation method may be adopted.

FIG. 2 shows a sequence chart of messages relating to a method to change home agent in the first embodiment of the invention. First, MR 130 transmits a BU message 60 to its home agent. Because MR 130 is connected to an access network 14, pHA 124 takes up the role of a home agent of MR 130 and performs processing on the BU message 60.

Next, VMN 140 transmits a BU message 210 to its home agent. MR 130 encapsulates this message in a tunnel packet 212. Then, pHA 124, which is behaving as a home agent of MR 130, receives this tunnel packet 212 and decapsulates it. In this case, pHA 124 recognizes that the decapsulated packet is the BU message 210 transmitted from VMN 140. In case VMN 140 also is a subscriber of the overlay network 110 of the home agent, pHA 124 takes up the role as the home agent of VMN 140. As a result, pHA 124 carries out the processing on the BU message 210 from VMN 140.

When MR 130 transfers the BU message 210 by tunneling, it may make decision to initiate route optimization on the route to and from a destination address described in the BU message 210. This condition to start the processing of the route optimization is shown in FIG. 2 as a return routability process (RR process) 214 on a route to and from the destination of the BU message 210.

However, pHA 124 can recognize that VMN 140 is present on the mobile network of MR 130 when the BU message 210 is received. In this case, the home agent of VMN 140 is substantially the entire overlay network (including pHA 124), and MR 130 has no need to carry out the return routability process on the route to and from the destination (i.e. home agent of VMN 140) of the BU message 210. Therefore, pHA 124 carries out a method to change home agent according to the present invention. Then, pHA 124, which is behaving as a proxy of the home agent of VMN 140, can transmit a change-HA message 218 to VMN 140. This change-HA message is encapsulated in a tunnel packet 216 to be transmitted to MN 130. After being decapsulated at MN 130, it is transmitted to VMN 140.

The change-HA message 218 is to notify to VMN 140 that its home agent should be changed to the same as the home agent of MR 130. Here, pHA 124 notifies the change-HA message 218 to VMN 140, while any node on the overlay network may notify as far as at least the notification of the change-HA message is concerned. The node on the overlay network to notify the change-HA message 218 can be determined dynamically or statically by an arbitrary method.

It is desirable that pHA 124 confirms whether VMN 140 can understand this change-HA message or not (i.e. whether it is an MN or not, which is provided with the functions according to the present invention), and that the change-HA message 218 is transmitted only to the VMN 140, which can understand it. For instance, in case VMN 140 does not have the functions according to the present invention, pHA 124 may judge whether MR 130 has the functions according to the present invention or not, and if MR 130 has the functions according to the present invention, it may be changed over to the execution of the method of correspondent router as to be described later.

When this change-HA message 218 is received, VMN 140 transmits a new BU message 220 to a new home agent (home agent of MR 130) as notified by the change-HA message 218.

Further, MR 130 transfers the BU message 220 to its own home agent in a tunnel packet 222. In case a home agent of MR 130 already present in a binding update list of MR 130 is given in a destination address field of the BU message 220, MR 130 has no need to initiate route optimization because optimization of the route between MR 130 and own home agent of MR 130 is already established.

In case MR 130 has changed the connection point or when a predetermined time-out period 230 has elapsed, MR 130 must transmit a new binding update message to all nodes as given in the binding update list. Here, it is assumed that only one node (the home agent of MR 130) is present in the binding update list of MR 130. In this case, MR 130 can transmit a BU message 232 to the home agent of MR 130 as given in the binding update list of MR 130. This BU message 232 is processed transparently by pHA 124 (or by an arbitrary proxy home agent assigned to MR 130 by the overlay network 110 of the home agent).

In FIG. 2, MR 130 has possibility to initiate optimization on the route to and from the destination of the BU message 210 (i.e. the home agent of VMN 140) at the time when the first BU message transmitted from VMN 140 is received. When the route optimization has been successfully carried out, the home agent of VMN 140 is added to the binding update list of MR 130. When the route optimization processing is carried out, MR 130 must transmit the BU message to the home agent of VMN 140 each time it moves or each time the binding must be renewed. As a result, redundant signaling is generated.

As described above, as the methods to cope with the redundant signaling, which may be generated when the home agent of VMN 140 is registered in the binding update list of MR 130, there are the following two methods:

First, after the change-HA message 218 is received, VMN 140 tries to prevent the transmission of the packet to its original home agent. In so doing, after a certain time period has elapsed without communication with the home agent of VMN 140, MR 130 judges that there is no need to have a route optimization session on the route to and from the original home agent of VMN 140, and the home agent of VMN 140 is deleted from the binding update list. As a result, the home agent of VMN 140 is deleted from the binding update list of MR 130, and redundant signaling is not generated.

Secondly, pHA 124 intercepts all messages transmitted to the home agent in the overlay network 110 and processes the message, and it also performs processing of signaling of return routability from MN 130. In this case, pHA 124 can guess that unnecessary route optimization is going to be established on the route to and from the home agent of the overlay network. Then, pHA 124 rejects the request of optimization of the route to and from the home agent of VMN 140, and MR 130 does not add the home agent of VMN 140 to the binding update list.

In addition to the processing method as described above, MR 130 may positively delete the home agent of VMN 140 registered in its own binding update list. In this case, MR 130 receives a notification that no entry relating to VMN 140 in the binding update list is required (i.e. that route optimization by VMN 140 is not required), and the entry relating to VMN 140 is deleted according to this notification. The notification that entry relating to VMN 140 in the binding update list is not needed may be given from pHA 124 or other overlay network node, or it may be given from VMN 140, which has changed the home agent. Also, this notification may be given by using the Use-CR message (to be described later), which is transmitted from pHA 124 or other overlay network node to MR 130. Also, MR 130 may recognize the destination of the BU message 220 (i.e. the home agent of MR 130) at the time of transfer of the BU messages 220 and 222 and may identify that the entry of VMN 140 (including the home agent of VMN 140) is not needed, and this entry may be deleted.

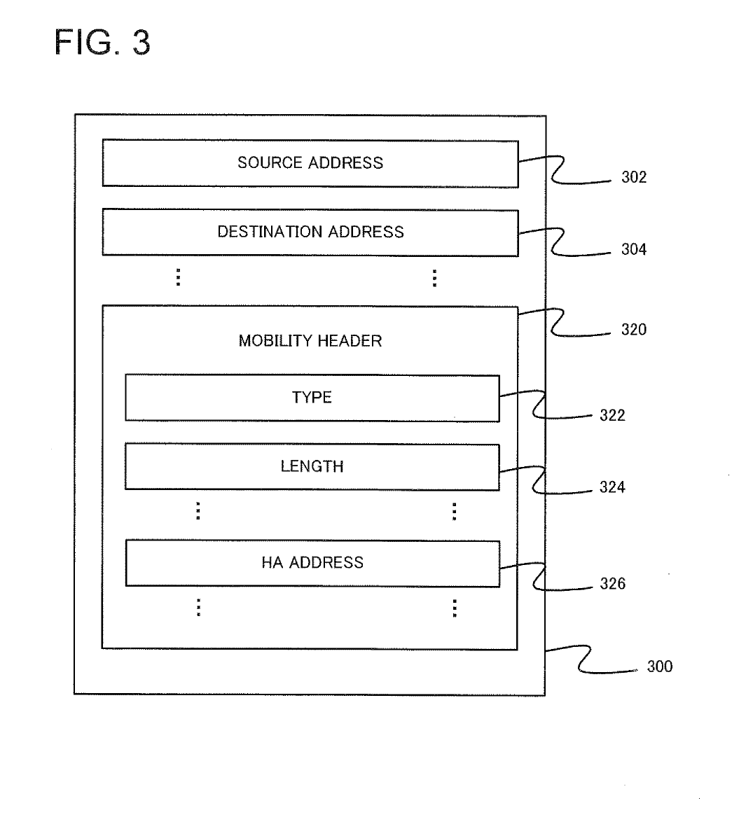

FIG. 3 shows an example of a format 300 of the change-HA message in the first embodiment of the invention. In FIG. 3, address of the transmitter is included in a source address field 302, and address of the receiver is included in a destination address field 304.

Although a mobility message is used as the change-HA message in this case, a message header of any type may be used as the change-HA message. In case of the mobility message, a mobility header 320 is included in the format 300 of the change-HA message.

In the type field 322, it is indicated that this message is a change-HA message. Also, size of the mobility header 320 is indicated in a length field 324. An HA address field 326 is present in the mobility header 320. An address of a new home agent, which requests change to the receiver, is included in this HA address field 326.

In the example shown in FIG. 2, an address of a home agent of VMN 140 is included as the content of the change-HA message 218 in the source address field 302. A care-of address of VMN 140 is included in the destination address field 304, and an address of a home agent of MR 130 is included in the HA address field 326. Other fields may be present in the format of the change-HA message, but the other fields are not shown here in order to facilitate the explanation. As the other fields in the message, there are, for instance: normal IPv6 header field such as home address destination option, flow label, etc., or encryption header field, etc.

As described above, in the method to change home agent, VMN 140 must understand the change-HA message and must be provided with new functions. Further, VMN 140 must be able to change a home agent with an address, which does not share the same prefix as the home address of the original home agent of VMN 140 or the home address of VMN 140. There are high possibilities that the new home agent of VMN 140 has the same address as that of the home agent of MR 130 and may have an address prefix different from the original home agent of VMN 140 or own address of VMN 140.

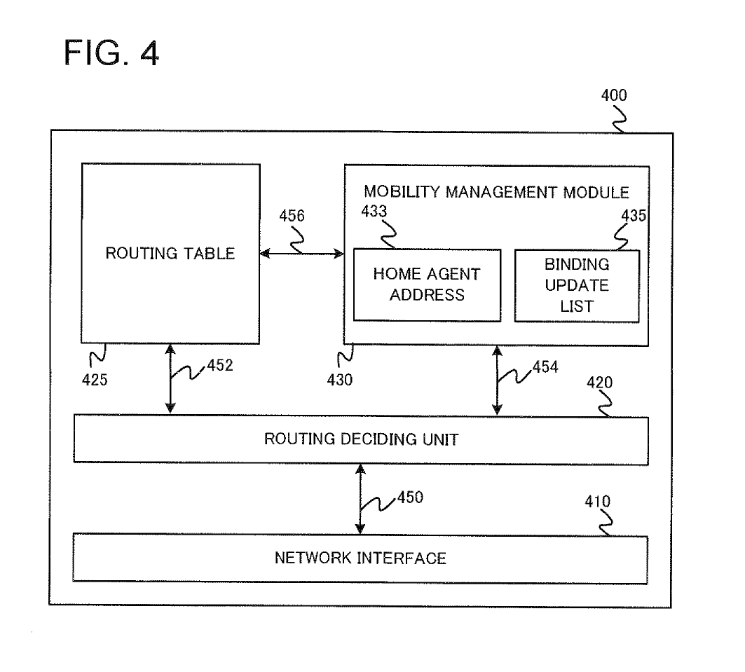

FIG. 4 shows a preferred functional architecture 400 of VMN 140 in the first embodiment of the invention.

VMN 140 has one or more network interfaces 410 for transmitting and receiving a packet, a routing deciding unit 420 for deciding a packet forwarding method or a packet transfer method, and a routing table 425 including information relating to the packet forwarding method or the packet transfer method (e.g. a mobility management module 430 provided with mobility management functions such as the Mobile IPv6).

The network interfaces 410 are functional blocks to include all of hardware and software required for communication with other nodes via any communication medium. When the terms known in the related technical field are used, the network interfaces 410 represent communication component, firmware, driver and communication protocol of a layer 1 (physical layer) and a layer 2 (data-link layer). In the functional architecture of VMN 140, one or more network interfaces 410 may be provided.

The routing deciding unit 420 has the function to make all decisions relating to the packet forwarding method. If the terms known in the related technical field are used, the routing deciding unit 420 is provided with a layer 3 (network layer) protocol such as IPv4, IPv6, etc.

In the routing table 425, there are included the rules to decide packet routing, which is referred when the routing deciding unit 420 makes decision. A list of routing entry is included in the routing table 425. In each routing entry, address of the next hop node, and/or destination address in the packet to be forwarded, source address and network interface 410 to deliver the packet according to the address and other information are included.

The routing deciding unit 420 updates entry of the routing table 425 via a signal/date path 452 and can extract the entry from the routing table 425. Also, the routing deciding unit 420 can transmit and receive the packet to and from an adequate network interface 410 via a signal/data path 450.

The mobility management module 430 fulfills the functions of the Mobile IPv6 in the mobile node. As these mobility management functions, there are included: transmission of the binding update message to the home agent and/or to the correspondent node, management of care-of address and home address, transfer of the packet to the home agent by using home address, receiving of the tunnel packet from the home agent, and others.

In the mobility management module 430, the binding update list 435 is included. In this binding update list 435, all nodes, to which mapping with home address and care-of address of the mobile node is notified, are recorded.

The mobility management module 430 has a home agent address 433, which is a new memory storage unit to store address of the current home agent. The mobile node must update the contents of the home agent address 433 each time a valid change-HA message is received.

The packet is transmitted between the routing deciding unit 420 and the mobility management module 430 via a signal path 454.

Also, the mobility management module 430 can update or retrieve routing information stored in the routing table 425 via a signal path 456. For instance, in case the mobility management module 430 has successfully transmitted the binding update message to a correspondent node or to a home agent, a route must be introduced to the routing table 425 so that the packet to be transmitted to the correspondent node or to the home agent thereafter can be forwarded via the tunnel interface by using the care-of address of the mobile node as transmission source.

### 2nd Embodiment

Next, description will be given on the method of correspondent router in the second embodiment of the invention. In this method of the correspondent router, a proxy home agent of the overlay network of the home agent assigned to the mobile router basically fulfills the function as a correspondent router on behalf of the home agent of the mobile network node.

Specifically, the proxy home agent of the mobile router notifies that the route optimization session is terminated on behalf of the home agent of the mobile network node, which is present behind the mobile router. As a result, the mobile router basically establishes route optimization to and from the proxy home agent in case it is wanted to initiate optimization of the route to and from the home agent of the mobile network node.

The proxy home agent behaves as the home agent of the mobile router and constantly receives notification of binding between the care-of address and the home address of the mobile router. Accordingly, there is no need that new signaling is carried out between the mobile router and the proxy home agent.

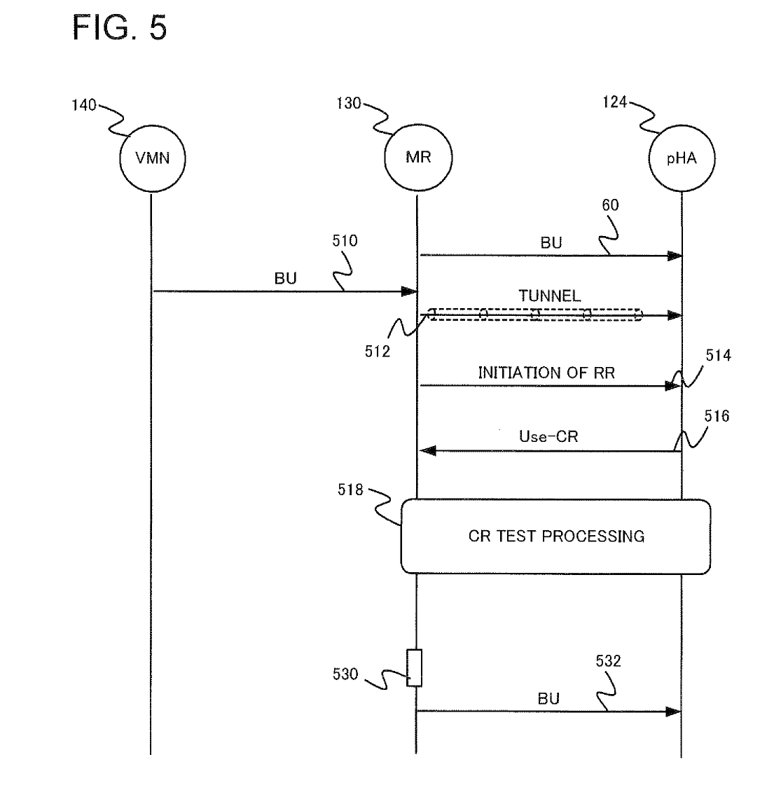

Referring to FIG. 5, description will be given below on operation in the second embodiment of the invention. FIG. 5 is based on the arrangement shown in FIG. 1A. That is, VMN 140 is connected to MR 130, and MR 130 is connected to an access network 14. In the overlay network 110 of the home agent, pHA 124 is transparently assigned to the home agent of MR 130 and VMN 140. It is necessary to confirm that any arbitrary node of the overlay network 110 (e.g. pHA 124) is a subscriber of the overlay network 110 of the home agent. However, there is no specific limitation in this method of confirmation and any arbitrary method of confirmation may be adopted.

FIG. 5 shows a sequence chart of messages relating to a method of correspondent router in the second embodiment of the invention. First, MR 130 transmits a BU message 60 to its home agent. Because MR 130 is connected to the access network 14, pHA 124 takes up the role of the home agent of MR 130 and performs processing on the BU message 60.

Next, VMN 140 transmits a BU message 510 to its home agent. MR 130 encapsulates this message into a tunnel packet 512. Then, pHA 124, which is behaving as a home agent of MR 130, decapsulates the received tunnel packet 512. In this case, pHA 124 recognizes that the packet after decapsulation is the BU message 510 as transmitted from VMN 140. In case VMN 140 is also a subscriber of the overlay network 110 of the home agent, pHA 124 takes up the role of the home agent of VMN 140. As a result, pHA 124 performs processing of the BU message 510 from VMN 140

In case MR 130 transfers the BU message 510 by tunneling, MR 130 may make decision to initiate route optimization on the route to and from the destination address as given in the BU message 510. This processing is shown as an Init RR message (RR initiation message) 514 to be transmitted and received to and from the destination of the BU message 510.

However, when pHA 124 receives the BU message 510, pHA 124 recognizes that VMN 140 is present in the mobile network of MR 130. Then, pHA 124 can use the method of correspondent router of the present invention so that the mobile router does not have to carry out redundant signaling.

Then, pHA 124, which is behaving as a proxy of the home agent of VMN 140, can transmit a Use-CR message 516 to MR 130 as a reply to the RR initiation message 514. This Use-CR message 516 is a notification that the receiver (i.e. MR 130) should use a correspondent router given in the Use-CR message 516 in order to establish optimization of the route to and from the transmitter (i.e. the home agent of VMN 140). The correspondent router described in the Use-CR message 516 is the home agent of MR 1301 for instance.

When the Use-CR message 516 is received, MR 130 performs a processing (CR test processing) 518 as option and may perform the testing on the validity of the correspondent router.

The present invention does not specifically define the method, by which MR 130 verifies the validity of the correspondent router, and any arbitrary method for verification may be used. As one of the preferred methods to verify the validity of the correspondent router, a method is known, for instance, according to which MR 130 transmits a test packet including a security token to the home agent of VMN 140, intercepts the packet and waits for the appearance of a specific correspondent router, which can give reply by using the security token. Also, a certificate signed by an authenticator, who can verify that a specific correspondent router has been authenticated, may be included in the Use-CR message 516.

When MR 130 recognizes that a specific correspondent router (i.e. the home agent of MR 130) is valid, it confirms whether or not a route optimization session is already established on the route to and from the correspondent router. For instance, in case the correspondent router is the home agent of MR 130, route optimization of communication to and from the home agent is already established by default. Therefore, MR 130 has no need to perform further signaling to establish route optimization on the communication to and from the correspondent router. On the other hand, in case route optimization is not established on communication to and from the correspondent router, it is desirable to perform signaling to establish route optimization to this correspondent router.

It is desirable to confirm that pHA 124 transmits the Use-CR message 516 only to MR 130, which can understand this Use-CR message, (i.e. an MR, which has the functions according to the present invention) before transmitting the Use-CR message 516. MR 130, which does not have the functions of the present invention, may try to carry out RR signaling by transmitting the RR initiation message 514 repeatedly regardless of whether the Use-CR message 516 is notified or not, but it is desirable that pHA 124 discards these RR initiation messages 514. Also, in case MR 130 does not have the functions according to the present invention, pHA 124 judges whether VMN 140 has the functions of the present invention or not. If VMN 140 has the functions of the present invention, it may be changed over to the method to change home agent as described above.

In case MR 130 changes the connection point or after a predetermined time-out period 530 has elapsed, it is necessary to transmit a new binding update message to all nodes, which are listed in the binding update list. It is supposed here that there is only one node (the home agent of MR 130) in the binding update list of MR 130. In this case, MR 130 should transmit only one BU message 532 as listed in the binding update list of MR 130. This BU message 532 is processed transparently by pHA 124 (or by any arbitrary proxy home agent assigned to MR 130 by the overlay network 110 of the home agent).

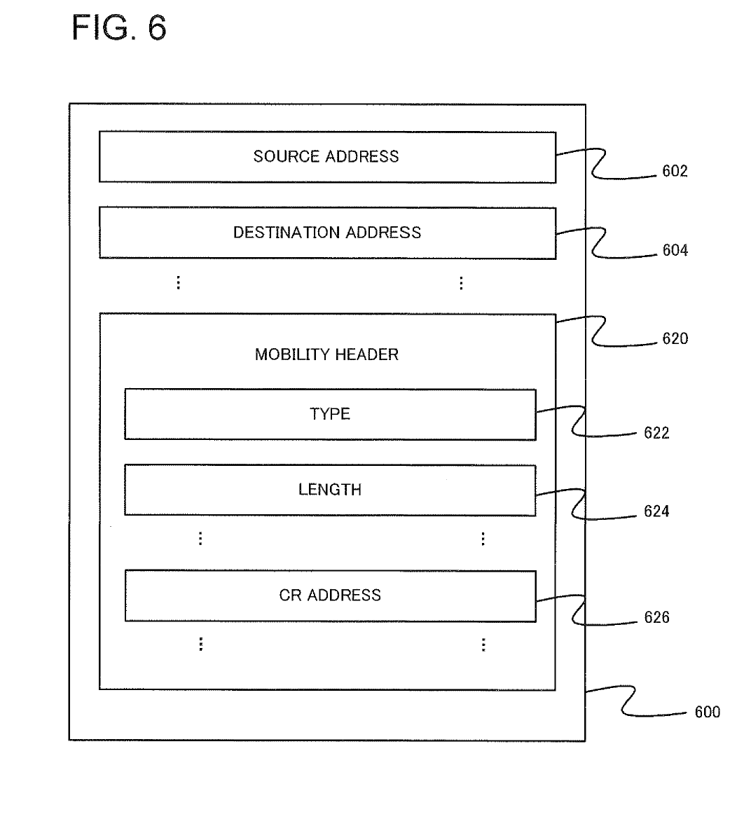

FIG. 6 shows an example of a format 600 of the Use-CR message in the second embodiment of the present invention. In FIG. 6, an address of the transmitter is included in a source address field 602, and an address of the receiver is included in a destination address field 604.

Although a mobility message is used in the Use-CR message, a message header of an arbitrary form may be used in the Use-CR message. In case of the mobility message, a mobility header 620 is included in the format 600 of the Use-CR message.

In a type field 622, it is indicated that this message is a Use-CR message. In a length field 624, size of a mobility header 620 is indicated. A CR address field 626 is present in the mobility header 620. In this CR address field 626, an address of a correspondent router is included, which should be used by the receiver of the Use-CR message when optimization is established on the route to and from the transmitter of the Use-CR message.

In the example shown in FIG. 5, an address of home agent of VMN 140 is included as the content of the Use-CR message 516 in a source address field 602. An address of MR 130 is included in the destination address field 604, and an address of a home agent of MR 130 is included in the CR address field 626.

The address of the home agent of MR 130 is already known to MR 130. Thus, by defining a flag to notify in the Use-CR message 516 that the home agent of MR 130 should be used as CR, notification may be given to MR 130 that the home agent of MR 130 is used as CR by the Use-CR message 516, which validates the flag.

Other fields may also be present in the format 600 of the Use-CR message. To facilitate the explanation, the other fields are neither described nor shown here. As the other fields within the message, there are included, for instance: normal IPv6 header field such as home address destination option, flow label, etc., or encapsulated header field, etc. Further, as the mobility header 620, information relating to the correspondent router such as the range of address where the correspondent router can terminate the route optimization session as a proxy may be included.

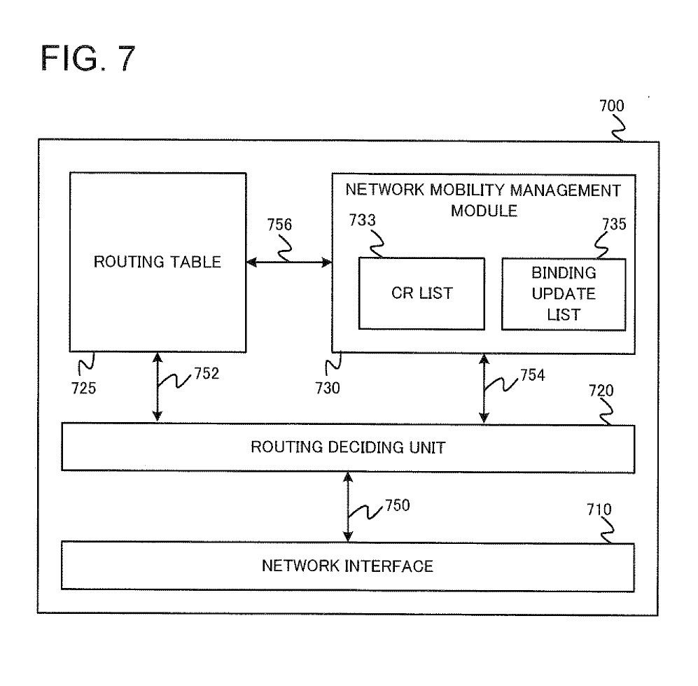

As described above, according to the method of correspondent router, MR 130 must understand the Use-CR message and must be provided with new functions. FIG. 7 shows a preferred functional architecture of MR 130 in the second embodiment of the invention.

MR 130 has one or more network interfaces to transmit and receive the packet, a routing deciding unit 720 for deciding packet forwarding method or packet transfer method, a routing table 725 including information relating to the packet forwarding method and the packet transfer method, etc., for instance, a network mobility management module 730 provided with network mobility management functions such as NEMO basic support.

The network interface 710 is a functional block including all types of hardware and software necessary for performing communication, which are needed by this node for performing communication with other node via an arbitrary communication medium. When the terms known in the related technical field are used, the network interface 710 represents communication component, firmware, driver and communication protocol of a layer 1 (physical layer) and a layer 2 (data-link layer). In the functional architecture of MR 130, one or more network interfaces 710 may be provided.

The routing deciding unit 720 has the functions to make all decisions on packet forwarding method. When the terms known in the related technical field are used, the routing deciding unit 720 is provided with a layer 3 (network layer) protocol such as IPv4, IPv6, etc., for instance.

In the routing table 725, the rules to determine routing of the packet are included, to which the routing deciding unit 720 should refer in decision-making processing. A routing entry list is included in the routing table 725. In each of routing entry, address of the next hop node, and/or source address and destination address present in the packet to be forwarded, and network interface 710, to which the packet is to be delivered according to other types information, are described.

The routing deciding unit 720 can update the entry of the routing table 725 via a signal/data path 752 and can extract the entry from the routing table 725. Also, the routing deciding unit 720 can transmit and receive the packet to and from adequate network interface 710 via a signal/data path 750.

The network mobility management module 730 fulfills the function of NEMO (network mobility) at the mobile router. Included in the network mobility management functions are: transmission of binding update message to the home agent, the correspondent node and/or the correspondent router, management of care-of address and home address, transfer of the packet to the home agent using a mobile network prefix, receiving of tunnel packet from the home agent, etc.

A binding update list 735 is included in the network mobility management module 730. In this binding update list 735, all nodes are recorded, to which mapping of home address and care-of address of the mobile router is notified.

The network mobility management module 730 has a correspondent router list (CR list) 733, which is a new memory storage unit. In the CR list 733, the correspondent router, or related node or related address, by which the correspondent router can terminate the route optimization session, are stored. Each time a valid Use-CR message is received, the mobile router must update the contents of the correspondent router list 733.

The packet is transmitted between the routing deciding unit 720 and the network mobility management module 730 via a signal path 754.

Also, the network mobility management module 730 can update or retrieve routing information stored in the routing table 725 via a signal path 756. For instance, when the network mobility management module 730 successfully transmits the binding update message to a correspondent node, a correspondent router, or a home agent, a route must be introduced to the routing table 725 so that the packet to be transmitted subsequently to the correspondent node, the correspondent router, or the home agent will be forwarded via a tunnel interface by using a care-of address of the mobile router as the transmission source.

In the above, two methods of solution according to the first and the second embodiments of the invention have been described. These two methods of solution may be statically fixed in a system or one of the two methods of solution may be dynamically selected.

Description will be given below on a method to determine which of these two methods of solution is proper and which method should be used by a proxy home agent of the overlay network of the home agent.

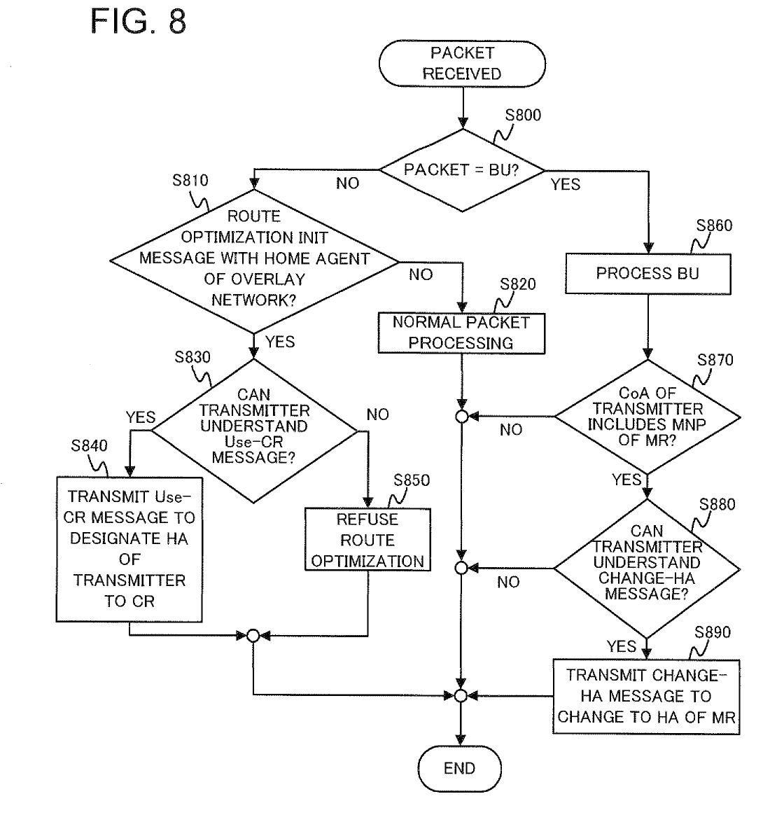

FIG. 8 shows an algorithm to be used by the proxy home agent for the processing of the received packet in the first and the second embodiments of the invention.

At the proxy home agent, it is confirmed whether the received packet contains a binding update (BU) message to be transmitted to the home agent in the overlay network or not (Step S800).

In case the received packet is a binding update message, the binding update message is processed (Step S860). After the binding update message is processed, a care-of address (CoA) given in the binding update message is checked, and it is confirmed whether a mobile network prefix (MNP) managed by the mobile router, which is subscribed in the overlay network of the home agent, is included in the care-of address given in the binding update message or not (Step S870).

If the mobile network prefix is not included in the care-of address, no special processing is performed.

On the other hand, if the mobile network prefix is included in the care-of address, it is confirmed whether the transmitter of the binding update message is supporting the method to change the home agent or not (whether the transmitter can understand the change-HA message or not) (Step S880).

The proxy home agent can recognize whether the transmitter is supporting the method to change home agent or not by various methods. For instance, the proxy home agent may statically recognize the information to indicate whether the transmitter is supporting the method to change home agent or not from the information on the arrangement of management.

Also, the change-HA message may be transmitted from the proxy home agent on the assumption that this method is supported by the transmitter. In this case, if there is no reply from the transmitter or if the transmitter continues to use the original HA (i.e. in case HA is not changed), it can be understood that the transmitter is not supporting the method to change home agent. In case the transmitter is not supporting the method to change home agent, no special processing is carried out.

On the other hand, in case the transmitter is supporting the method to change home agent, the proxy home agent transmits the change-HA message to send the home agent of the mobile router as a new home agent to this transmitter (Step S890). The home agent of the mobile router manages the mobile network prefix, which constitutes the care-of address of the transmitter.

In case the received packet is not the binding update message in Step S800, it is checked whether this packet contains a message to initiate optimization of the route to and from the home agent of the overlay network (Step S810).

As examples of the message to initiate the route optimization, there are: Care-of Test Init (COTI) message or Home Test Init (HoTI) message of return routability process.

If the packet does not contain such message, normal processing (e.g. normal transfer processing) is carried out on the packet (Step S820).

On the other hand, if the received packet is a message to initiate the route optimization, it is confirmed whether the transmitter of the received packet is supporting the method of correspondent router or not (Step S830).

The proxy home agent can recognize whether the transmitter is supporting the method of correspondent router or not. For instance, the proxy home agent may statically recognize the information to indicate whether the transmitter is supporting the method of the correspondent router or not from the information based on the arrangement of management.

Or, the Use-CR message may be transmitted from the proxy home agent on the assumption that this method is supported by the transmitter. In this case, if there is no reply from the transmitter or if the transmitter continues to perform processing of route optimization, it is understood that the transmitter is supporting the method of the correspondent router.

In case the transmitter is not supporting the method of the correspondent router, the proxy home agent carries out the processing to refuse the attempt of route optimization, e.g. discard of the method to initiate route optimization (Step S850).

On the other hand, in case the transmitter is supporting the method of the correspondent router, the proxy home agent transmits the Use-CR message to the transmitter (Step S840). By this Use-CR message, the home agent of the transmitter is designated as a correspondent router, which the transmitter uses to establish the route optimization.

In the present invention, drawings and description are given so that the present invention is represented in the most practical and the preferred embodiments, while it would be obvious to those skilled in the art that various changes and modifications can be made in the details of design and parameters relating to the component elements without departing from the spirit and the scope of the invention. For instance, the present invention can also be applied to an overlay network, which provides route optimization to both of a mobile host and a mobile router. Further, the invention can also be applied to both of a mobile host, which operates the Mobile IPv6, or to a mobile router, which operates the network mobility support. For instance, it is evident that the present invention can be applied to a mobile host and a mobile router in relation to an overlay network, which provides route optimization support. Also, the invention does not depend on the number of nestings of the mobile router. Further, description has been given in the above on a case where the overlay network is arranged on a global network, while the invention can also be applied to local mobility management. For instance, by PMIP (Proxy Mobile IP), which is one of the methods of the local mobility management, mobility support is provided to a mobile terminal through registration of moving of the mobile terminal by MAG (Mobile Access Gateway) to LMA (Local Mobility Anchor), while the home agent and the proxy home agent in the present specification can be applied in a manner corresponding to MAG. Here, various cases can be conceived, e.g. a case where a certain time moment is taken as reference (a relative case), or a case with the condition to register to network operator (a definite case), and the other home agent, receiving registration information from the home agent, which serves as a starting point of movement of the mobile node, may be regarded as corresponding to MAG.

In the present specification, description is given by using terms such as home agent and proxy home agent, while it will be obvious to those skilled in the art that the relation between a home agent (home agent of initial setting) for mobile terminal and a proxy home agent is a relation, which is relative and changes over time. That is, a home agent to a certain mobile terminal may be a proxy home agent to another mobile terminal. Or, on the contrary, to a certain mobile terminal, a proxy home agent can be a home agent to another mobile terminal. Further, in case of the same mobile terminal, a proxy home agent at a certain moment may become a home agent after moving, change of setting etc., and what has been a home agent previously may become one of proxy home agents. In the embodiments as described above, assumption is made on a mobile network (or a hierarchical mobile network), which comprises a mobile router (and the nodes under its control). With regard to this feature, the present invention can also be applied to the condition of local mobility management. For instance, the mobile router in the present specification can be applied in a manner corresponding to MAG. In this case, the home agent of the mobile router may correspond to LMA. The hierarchical mobile network corresponds to a case where the network operator providing the network by adopting PMIP uses the tunnel between MAG-LMA comprising PMIP in multi-stage based on a roaming relation. Further, the functions of the mobile router of the present invention can also be applied not only to a mobile router as an entity but also to a case where it moves in the network as a logical entity (to provide the condition corresponding to the condition in moving to the mobile network under control). Even when the connection point is changed, this corresponds to the case where context transfer is carried out for the purpose not to change the network prefix to be notified to the mobile nodes under control.

Each functional block used in the description of the embodiments of the present invention as given above can be realized as LSI (Large Scale Integration), typically represented by the integrated circuit. These may be produced as one chip individually or may be designed as one chip to include a part or all. Here, it is referred as LSI, while it may be called IC, system LSI, super LSI, or ultra LSI, depending on the degree of integration.

Also, the technique of integrated circuit is not limited only to LSI and it may be realized as a dedicated circuit or a general-purpose processor. FPGA (Field Programmable Gate Array), which can be programmed after the manufacture of LSI, or a reconfigurable processor, in which connection or setting of circuit cell inside LSI can be reconfigured, may be used.

Further, with the progress of semiconductor technique or other techniques derived from it, when the technique of circuit integration to replace LSI may emerge, the functional blocks may be integrated by using such technique. For example, the adaptation of biotechnology is one of such possibilities.

### INDUSTRIAL APPLICABILITY

The present invention provides such effects that generation of redundant signaling is reduced when a mobile router receives a network-based route optimization service provided by an overlay network and also when a mobile node connected to the mobile router receives a network-based route optimization service provided by the overlay network. The invention can be applied to a technical field relating to an overlay network, which is abstractly represented in a packet-exchange type data communication network such as IP network, to a technical field relating to route optimization in mobility management, and also to a technical field relating to network mobility.

1. An overlay network node, belonging to an overlay network formed on top of a predetermined network, and having functions relating to an overlay network service of a home agent, comprising:
means for identifying a mobile router or a mobile node subscribed in said overlay network service; and
message transmitting means for detecting a condition where a mobile node receiving said overlay network service is connected to a mobile network of a mobile router receiving said overlay network service, and for, when a message relating to route optimization processing is received from said mobile router, transmitting a notification message to said mobile router or said mobile node in order to suppress transmission of a message relating to the route optimization processing from said mobile router.

2. The overlay network node according to claim 1, wherein said message transmitting means transmits said notification message to instruct to change the home agent of said mobile node to a predetermined home agent.

3. The overlay network node according to claim 2, wherein said predetermined home agent is a home agent of said mobile router.

4. The overlay network node according to claim 2, comprising means for discarding a message relating to route optimization processing to the home agent before the change of said mobile node from said mobile router after said notification message is transmitted by said message transmitting means.

5. The overlay network node according to claim 2, comprising means for confirming whether said mobile node can understand said notification message before transmission of said notification message by said message transmitting means.

6. The overlay network node according to claim 2, comprising means for notifying to said mobile router that route optimization processing for said mobile node by said mobile router is not needed.

7. The overlay network node according to claim 1, wherein said message transmitting means transmits, to said mobile router, said notification message to instruct that an optimized route of communication being carried out by said mobile router is terminated in a predetermined node on a network.

8. The overlay network node according to claim 7, wherein said predetermined node is a home agent of said mobile router.

9. The overlay network node according to claim 7, comprising means for confirming whether said mobile router can understand said notification message or not before transmission of said notification message by said message transmitting means.

10. The overlay network node according to claim 1, comprising means for judging which of processings should be performed among a processing to instruct said mobile node to change the home agent of said mobile node to a predetermined home agent, and a processing to instruct said mobile router that an optimized route of communication being performed by said mobile router is terminated in a predetermined node on a network.

11. A mobile router subscribed in an overlay network service of a home agent, comprising
means for receiving, from an overlay network node providing said overlay network service, a notification message to instruct that an optimized route of communication is terminated in a predetermined node on the network; and
means for performing processing to make a predetermined node to terminate a route of said communication.

12. The mobile router according to claim 11, comprising means for verifying validity of said predetermined node to be notified by said notification message.

13. The mobile router according to claim 11, comprising means for storing an address of said predetermined node to be notified by said notification message.

14. The mobile router according to claim 11, comprising means for confirming whether an optimized route is established or not on communication with said predetermined node to be notified by said notification message and for establishing the optimized route if the optimized route is not established.

15. The mobile router according to claim 11, comprising:
means for receiving a notification from said mobile router or a specific mobile node that route optimization processing for said specific mobile node connected to its own mobile network is not needed; and
means for deleting information of route optimization relating to said specific mobile node from its own binding update list.

16. A mobile node, being subscribed in an overlay network service of a home agent, comprising.
means for receiving, from an overlay network node providing said overlay network service, a notification message to instruct to change the home agent to a predetermined home agent; and
means for performing processing to change the home agent to said predetermined home agent.

17. The mobile node according to claim 16, comprising means for storing an address of said predetermined home agent to be notified by said notification message.

18. The mobile node according to claim 16, comprising means for controlling in such manner that a packet is not transmitted to a home agent before change until a predetermined time period elapses.

19. The mobile node according to claim 16, comprising means for notifying said mobile router that route optimization processing for said mobile node by said mobile router is not needed.
